(19) United States
(12) Patent Application Publication
(10) Pub. No.: US 2020/0204734 A1
(43) Pub. Date: Jun. 25, 2020

(54) SYSTEM AND METHOD FOR INCREASING COVERAGE OF AN AREA CAPTURED BY AN IMAGE CAPTURING DEVICE

(71) Applicant: ELBIT SYSTEMS ELECTRO-OPTICS ELOP LTD., Rehovot (IL)

(72) Inventors: Shalom BINDER, Rehovot (IL); Nachum AVISHAY, Rehovot (IL); Dov FREIMAN, Rehovot (IL); Yotam PAYKIN, Rehovot (IL)

(73) Assignee: ELBIT SYSTEMS ELECTRO-OPTICS ELOP LTD., Rehovot (IL)

(21) Appl. No.: 16/500,418

(22) PCT Filed: Mar. 29, 2018
(86) PCT No.: PCT/IL2018/050380

§ 371 Date: Oct. 3, 2019

(30) Foreign Application Priority Data
Mar. 4, 2017 (IL) 251544

(51) Int. Cl. H04N 5/232; G06T 7/80; H04N 17/00

(52) U.S. Cl. CPC H04N 5/23283; H04N 17/002; G06T 7/80

(57) ABSTRACT

A system and a method of increasing an area continuously captured by an image capturing device directed at said area are provided herein. The method may include the following steps: directing said image capturing device at said area in a specified image orientation; receiving momentary orientation measurements of said image capturing device; calculating in real-time, based on said measurements, a shift in orientation of said image capturing device relative to said specified image orientation; providing instructions for rotation in real-time of said image capturing device, to compensate for said shift; and rotating, using a rotation mechanism, said image capturing device based on said instructions, wherein the image capturing device is mounted on a non-stationary platform moving in a periodic pattern.

### FIELD OF THE INVENTION

The present invention relates generally to the field of platform-mounted image capturing devices, and more particularly to image manipulations applied on same.

### BACKGROUND OF THE INVENTION

Prior to the background of the invention being set forth, it may be helpful to provide definitions of certain terms that will be used hereinafter.

The term Wide-Area-Motion-Imagery (WAMI) as used herein is defined as video capturing of an area the size of a town or city. It is a system that uses one or more cameras mounted on some form of a gimbal on an aircraft or blimp to capture a very large area on the ground, from about once every second up to several times per second.

The term “temporary coverage” as used herein is the area covered by an image capturing device on an aerial vehicle flying in a periodic flight pattern over a period of time which is a fraction of the time required for the aircraft to complete its periodic flight pattern. The temporary coverage can account to a single or a few frames taken in close temporal proximity to each other.

The term “continuous coverage” as used herein is the area covered by an image capturing device on an aerial vehicle flying in a periodic flight pattern over a the entire period of time required for the aircraft to complete its periodic flight pattern. The continuous coverage is the area captured continuously throughout the cycle.

The term “periodic pattern” or “periodic movement pattern” as used herein is a pattern according to which the platform repeatedly moves, starting and ending its route substantially at the same location and repeating it over and over again, not necessarily along the same route.

The term “specified image orientation” as used herein is the rotational angle by which an image captured by an image capturing device is set. It may be predefined by a user or automatically and may also be updated in real time. In short—it is defined by the task and may take into account the scene and the objects to be under surveillance.

The introduction of Wide-Area-Motion-Imagery (WAMI) to operational users has provided a monumental gain in Intelligence, Surveillance, and Reconnaissance (ISR) collection and exploitation.

Advantageously, operational commanders can send a single platform over an area of interest. Both forward operators and exploitation centers in the rear can use this data to meet their objectives.

One of the challenges of WAMI sensing is dealing with the non-stationary nature of the aerial platform holding the image capturing device. In a case of a fixed wing aircraft, in order to capture the same area, the aerial vehicle needs to fly in circular patterns. This leads to the undesirable effect of the captured imagery to be constantly rotated along an axis associated with the circular pattern of the aerial vehicle.

FIG. 1 shows an aerial view of a scene 110, a flight route 112 of an aerial vehicle, and capturing pattern 140 of an image capturing device mounted on the aerial vehicle, in accordance with the prior art. Specifically, the capturing device has an over view 120 being rectangular in nature. Capturing the scene from a different position and orientation as the aerial vehicle flies along the flight route, as shown in multiple capturing pattern 140 leads to a very reduce overlapping area 130 which is required by WAMI and other applications that need a continuous (or semi continuous) capturing of the scene.

FIG. 2 shows three snapshots taken from a video footage of WAMI exhibiting 3 partially overlapping image tiles. The images of this video footage were digitally rotated by means of image processing software after the capturing of each image in accordance the prior art. The main drawbacks for the aforementioned method is the excessive use of processing resources as well as latency due to the heavy amount of data that is needed to process. Yet another drawback is that carrying out the compensation of the mis-orientation post capturing does not yield optimal correction as the capturing has already occurred and missing pixels (of areas not covered in the capturing) cannot be recovered.

FIG. 3 is a diagram an aerial vehicle capturing an area on the ground with a capturing device having a high aspect ratio, in accordance with the prior art. An aerial vehicle is shown in three positions 300A, 300B, and 300C where respective image capturing device in three respective positions 310A, 310B, and 310C captures three respective strips 320A, 320B, and 320C having a high aspect ratio (e.g. over 1:5).

Due to the flight mute of aerial vehicle 300 the overlapping area 340 required, for example, for WAMI, is significantly reduced (about 10% or less) compared with the original over view of capturing device 310. This diagram demonstrates that for high aspect ratio WAMI, the undesirable orientation of the image capturing device has the most dramatic impact.

### BRIEF SUMMARY OF THE INVENTION

Some embodiments of the present invention suggest to harness the non-stationary nature of the platform on which the image capturing device is mounted, to not only effectively address the undesirable rotational alignment of the cameras but also to primarily increase the overall continuous coverage of the area captured by the WAMI or any other airborne image capturing payload.

These additional, and/or other aspects and/or advantages of the present invention are set forth in the detailed description which follows.

### BRIEF DESCRIPTION OF THE DRAWINGS

For a better understanding of the invention and in order to show how it may be implemented, references are made, purely by way of example, to the accompanying drawings in which like numerals designate corresponding elements or sections. In the accompanying drawings:

FIG. 1 shows an aerial view of a scene, a flight route of an aerial vehicle, and capturing pattern of an image capturing device mounted on the aerial vehicle, in accordance with the prior art;

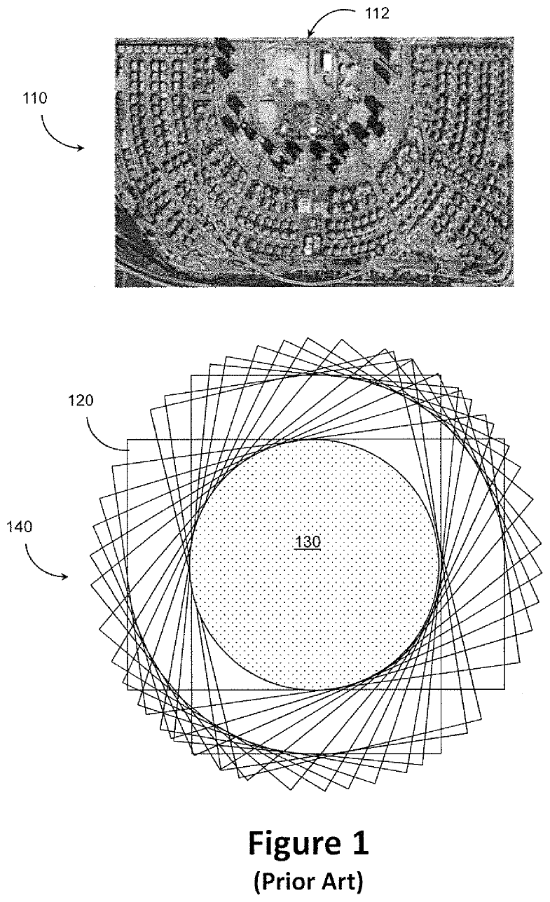

FIG. 2 is a diagram illustrating an aspect of a correction of an orientation shift of the captured image carried out post capturing, in accordance with the prior art;

FIG. 3 is a diagram an aerial vehicle capturing an area on the ground with a capturing device having a high aspect ratio, in accordance with the prior art;

FIG. 4 is a block diagram illustrating non-limiting example of the system according to some embodiments of the present invention;

FIGS. 5A and 5B are optical design diagrams illustrating an exemplary non-limiting implementation of some embodiments of the present invention;

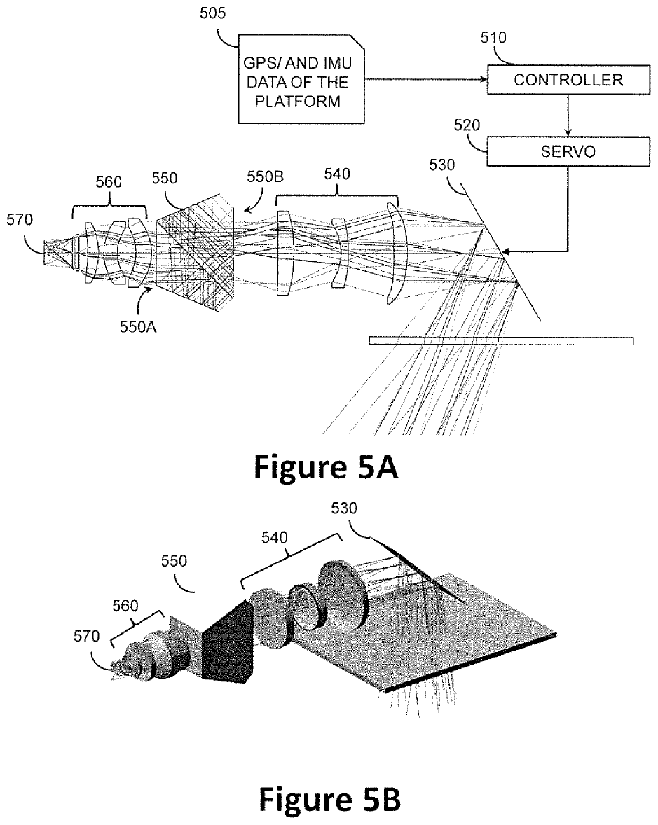

FIG. 6 is a diagram an aerial vehicle capturing an area on the ground with a capturing device having a high aspect ratio, in accordance with some embodiments of the present invention;

FIG. 7A is a diagram an aerial vehicle capturing two non-overlapping areas on the ground with a capturing device, in accordance with some embodiments of the present invention;

FIG. 7B is a diagram of a ground vehicle capturing at least two areas on the ground with a capturing device, in accordance with some embodiments of the present invention; and

FIG. 7C is a diagram of a stationary watchtower illustrating an aspect in accordance with some embodiments of the present invention;

FIG. 7D is a diagram of a ship illustrating an aspect in accordance with some embodiments of the present invention;

FIG. 8 is a diagram illustrating 3×3 array of tile images captured by an image capturing device in accordance with some embodiments of the present invention; and

FIG. 9 is a high level flowchart illustrating a method in accordance with embodiments of the present invention.

### DETAILED DESCRIPTION OF THE INVENTION

With specific reference now to the drawings in detail, it is stressed that the particulars shown are for the purpose of example and solely for discussing the preferred embodiments of the present invention, and are presented in the cause of providing what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

Before explaining the embodiments of the invention in detail, it is to be understood that the invention is not limited in its application to the details of construction and the arrangement of the components set forth in the following descriptions or illustrated in the drawings. The invention is applicable to other embodiments and may be practiced or carried out in various ways. Also, it is to be understood that the phraseology and terminology employed herein is for the purpose of description and should not be regarded as limiting.

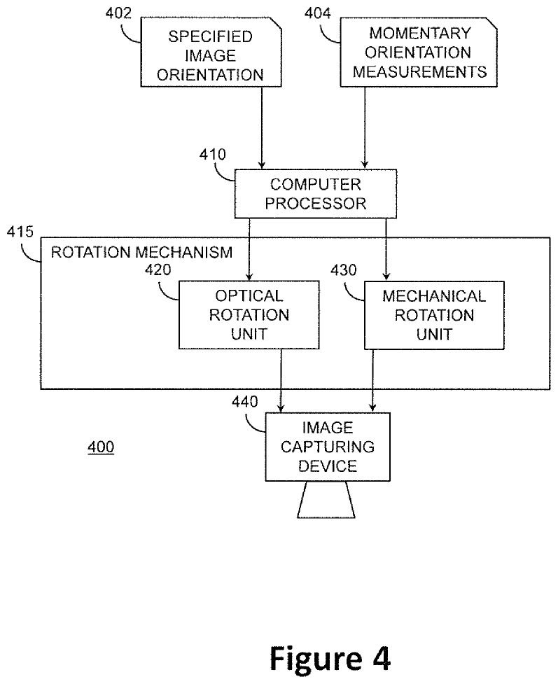

FIG. 4 is a block diagram illustrating non-limiting example of a system 400 for increasing an area continuously captured by an image capturing device 440 directed at the area, according to some embodiments of the present invention. System 400 may include an image capturing device 440 directed at the area in a specified image orientation 402. System 400 may further include a computer processor 410 configured to: receive momentary orientation measurements 404 of image capturing device 440; calculate in real-time, based on the measurements, a shift in orientation of the image capturing device relative to specified image orientation 402; and provide instructions for rotation in real-time of image capturing device 440, to compensate for the shift. System 400 may further include a rotation mechanism 415 (possibly including an optical rotation unit 420 or a mechanical rotation unit 430) configured to rotate image capturing device 440 based on the instructions. It is noted herein that in various embodiments of the present invention, rotation mechanism 415 and its parts may be either external, internal or partially embedded in image capturing device 440.

According to some embodiments of the present invention, image capturing device may be mounted on a non-stationary platform moving in a periodic pattern. According to some embodiments of the present invention, the platform may be an aerial platform and wherein the periodic pattern is a flight route which may be circular. In some embodiment, the calculation of the shift compensation is based in part on the periodic pattern and its predictability.

According to some embodiments of the present invention, the platform may be one of: a naval vessel, a ground vehicle, an aerostat, and a semi-stationary platform.

According to various embodiments, the actual rotation by rotation mechanism 415 may be carried out by optical rotation via optical elements rotation unit 420, a mechanical sensor rotation unit 430 or a combination thereof.

Figures SA and SB are optical design diagrams illustrating an exemplary non-limiting implementation of the according to some embodiments of the present invention. While a potential mechanism for carrying out the selective rotation may be implemented by a set of gimbals external to the optical instrument, this solution may have some drawbacks such as relatively high weight and volume.

According to some embodiments of the present invention, the rotation mechanism may include at least one gimbal. Alternatively and additionally, the rotation mechanism may include a Schmidt-Pechan prism.

According to some embodiments of the present invention, in order to meet requirement of a super compact optical rotation unit, to fit in a small payload housing, the inventors have uniquely designed Schmidt-Pechan prism 550 to accommodate a similar width of the beam of the folded image at the beam input side 550A of Schmidt-Pechan prism 550 and at beam output side 550B of Schmidt-Pechan prism 550. This design guarantees optimal use of the substance of Schmidt-Pechan prism 550 which is of significant importance since Schmidt-Pechan prism 550 is located along converging beams which requires the beam output side 550A to be larger than beam input side 550A.

The aforementioned property, as clearly shown by the ray tracing diagram, enables a compact and light weighted Schmidt-Pechan prism 550 that can be fitted into the aforementioned mechanism 500 within a payload of an aerial vehicle.

Another possible non-limiting embodiment is the use of Dove or Delta prisms which can be used only in collimated beam, otherwise, astigmatism was created and affect the performance.

According to some embodiments of the present invention, the image capturing device produces a sequence of images, wherein the selective rotation of the optical instrument relative to the sensor results in the sequence of images exhibiting a mostly overlapping captured area.

By way of illustration, the coverage ratio between a temporary coverage and a continuous coverage of an image capturing device having an coverage specific aspect ratio of a:b can be calculated by the following formula (1) below:

$$\frac{{S}_{▪}}{{S}_{0}} = \frac{a \cdot b}{π \cdot {( \frac{a}{2} )}^{2}} = \frac{4 \cdot a \cdot b}{π \cdot {a}^{2}} = \frac{4 \cdot b}{π \cdot a} \qquad ( 1 )$$

Wherein S_{▪} denotes a temporary coverage and S₀ denotes the continuous area coverage and a and b are the sides of the image captured by capturing device defining the aspect ratio a:b of the image.

A non-limiting example of an aspect ratio of 4:3 can be demonstrated in the following formula (2) below:

$$\frac{{S}_{▪}}{{S}_{0}} = \frac{a \cdot b}{π \cdot {( \frac{a}{2} )}^{2}} = \frac{4 \cdot a \cdot b}{π \cdot {a}^{2}} = \frac{4 \cdot b}{π \cdot a} = \frac{4 \cdot 1.25 a}{π \cdot a} = \frac{4 \cdot 1.33}{π} \approx 1.7 \qquad ( 1 )$$

It is evident that the coverage ratio becomes larger, with a larger aspect ratio. A larger coverage ratio means a higher loss of coverage due to the circular pattern of the aerial vehicle. A problem addressed by embodiments of the present invention as described herein.

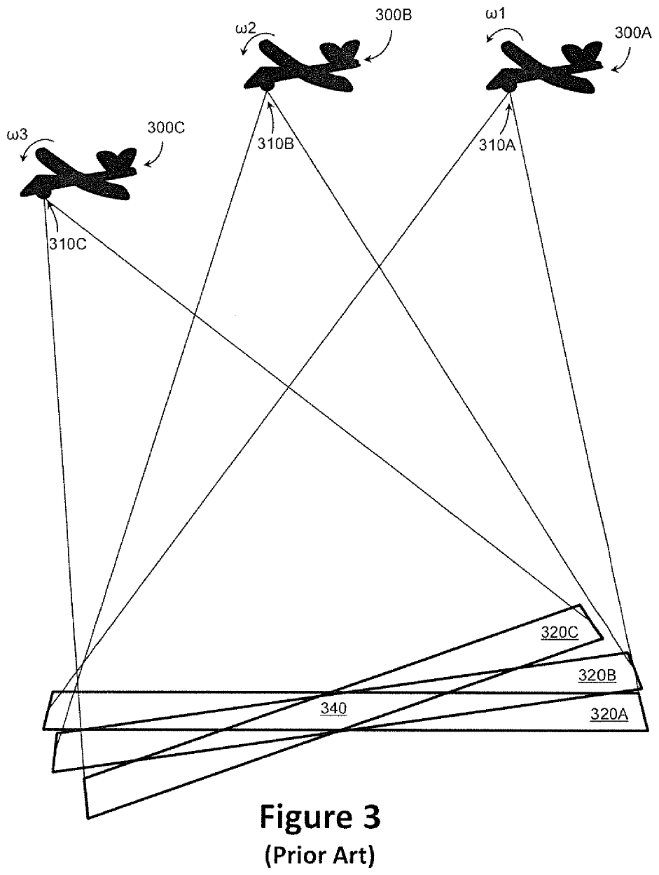

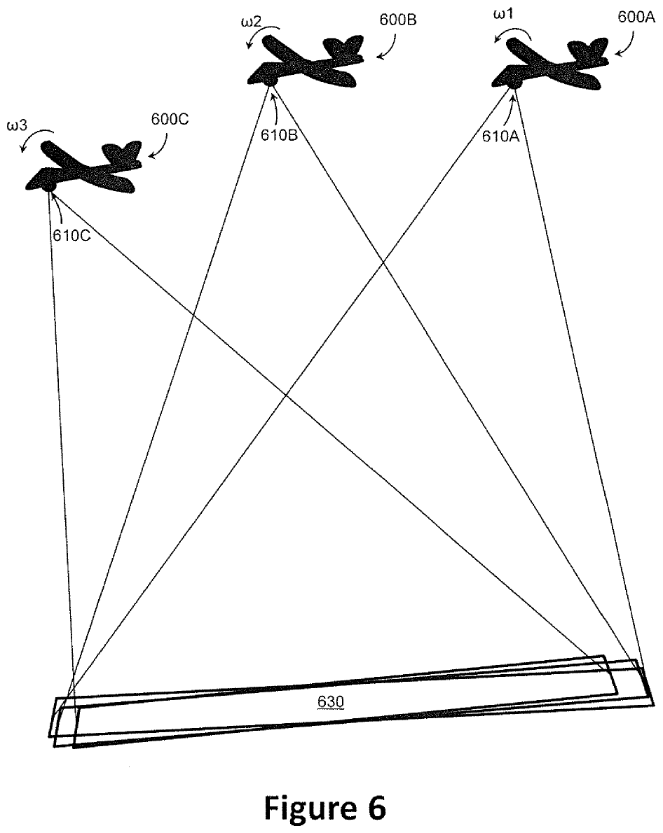

FIG. 6 is a diagram an aerial vehicle capturing an area on the ground with a capturing device having a high aspect ratio, in accordance with some embodiments of the present invention. An aerial vehicle is shown in three positions 600A, 600B, and 600C where respective image capturing device in three respective positions 610A, 610B, and 610C captures three respective strips 620A, 620B, and 620C having a high aspect ratio (over 1:5). As opposed to FIG. 3 discussed above where imaging device 310 has not be rotated in real time, here imaging device 610 is being rotated in real-time based on momentary data concerning position and orientation of aerial vehicle 600 so that strips 620A, 620B, and 620C are mostly overlapping.

According to some embodiments of the present invention, the image capturing device may have an aspect ratio of over 1:R, where R>2, wherein the rotation yields an increase in the captured area by a sequence of captured images, of at least R times, compared to a similar area without the rotation. As demonstrated in aforementioned formulae (1) and (2) above, the reduction in coverage area is most severe for image capturing devices having a high aspect ratio.

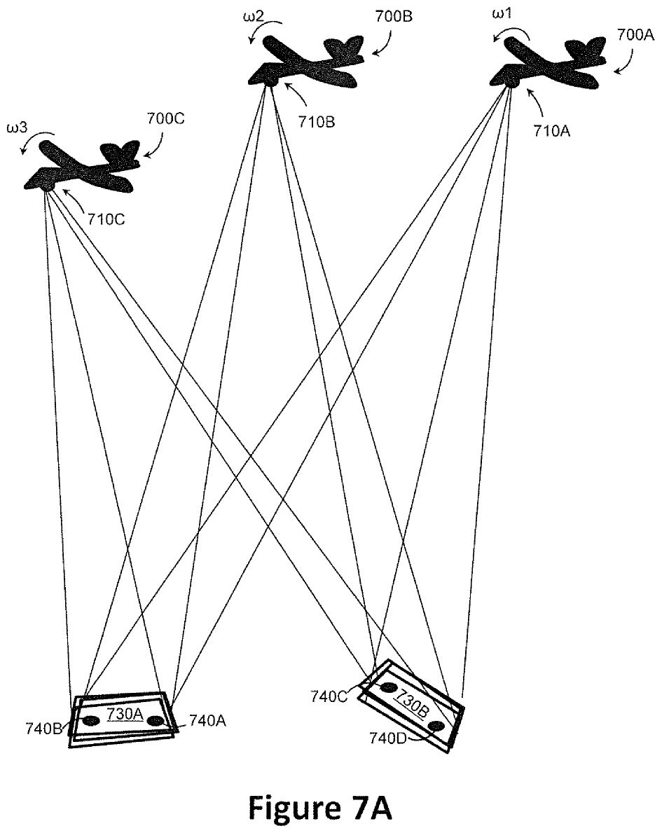

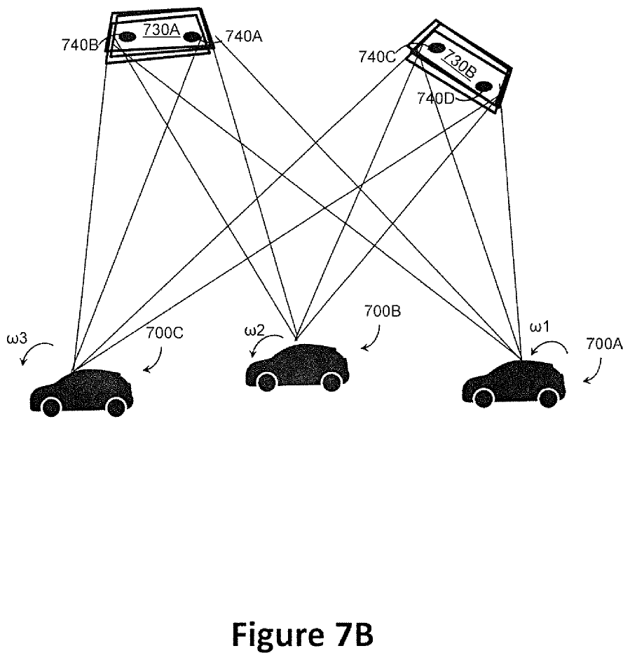

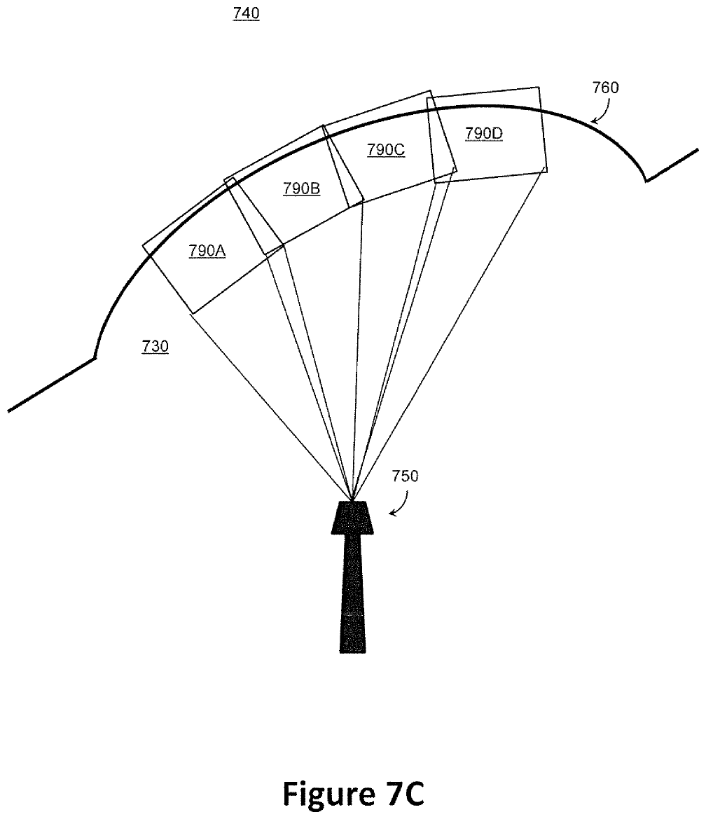

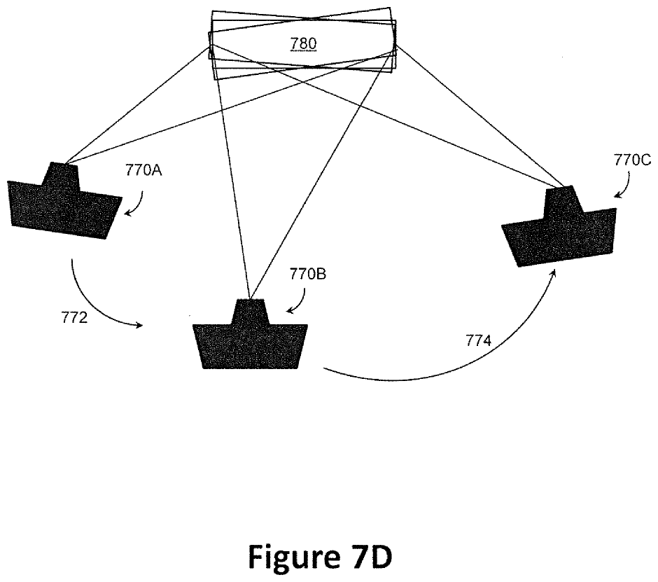

FIG. 7A is a diagram an aerial vehicle capturing two non-overlapping areas on the ground with a capturing device, in accordance with some embodiments of the present invention. According to some embodiments of the present invention, the image capturing device may be configured to capture at least two non-overlapping images each associated with a respective specified image orientation and wherein the computer processor and the rotation mechanism are further configured to operate for each of the non-overlapping images separately, based on the respective specified image orientations.

As clearly shown in the diagram, the non-overlapping areas 730A and 730B of the scene may be captured in a totally different orientation angle. This demonstrates the flexibility enabled by the independent orientation applied to each frame captured by the image capturing device. One advantage of this feature is an optimized capturing of the area and specifically, objects of interests 740A and 740B covered by area 730A and objects of interests 740C and 740D covered by area 730B which was orientated differently in order to capture objects of interests 740C and 740D.

FIG. 7B is a diagram a ground vehicle capturing one or more non-overlapping areas on the ground with a capturing device, in accordance with some embodiments of the present invention. This figure demonstrates that any reference to an aerial vehicle or platform in this disclosure may be similarly applied to surface or near surface platforms such as ground platforms (e.g. cars, trains) or maritime platforms (e.g. ships) or other aerial platforms (e.g. quadcopters, aerostats).

In a case that the image capturing device is located on a car driving on a variable terrain, the capturing device on the car may be configured to capture one or more images, the selective rotation may be applied separately and independently to each image so as to compensate a respective shift in each of the images. As clearly shown in the diagram, the non-overlapping areas 730A and 730B of the scene may be captured in a totally different orientation angle. This demonstrates the flexibility enabled by the independent orientation applied to each frame captured by the image capturing device. As with the footage captured by the aerial platform, one advantage of this feature is an optimized capturing of the area and specifically, objects of interests 740A and 740B covered by area 730A and objects of interests 740C and 740D covered by area 730B which was orientated differently in order to capture objects of interests 740C and 740D.

FIG. 7C illustrates a stationary watchtower 750 with a controllable image capturing device mounted on it in accordance with embodiments of the present invention. The image capturing device on watchtower 750 scans a scene that include hill 730. In order to avoid unnecessary capturing of sky 740 is possible to rotate the orientation of capturing device so as not to capture or at least minimize or significantly reduce the portion of sky that extends beyond the horizon of hill edge 760, thus maximizing the land area which is covered.

In accordance with some embodiments of the present invention, the image capturing device is set to a specified image orientation. In some embodiments, the specified image orientation may be selected so as to reduce capturing of regions of the area indicated as non-relevant regions. In some embodiments, the specified image orientation may be determined by one of: an automatic decision module, a human operator.

According to some embodiments of the present invention, a system for preserving a specified image orientation of images captured by an image capturing device is provided herein. The system may include: an image capturing device directed to scan an area in a specified image orientation; a computer processor configured to: receive momentary orientation measurements of the image capturing device; calculate in real-time, based on the measurements, a shift in orientation of the image capturing device relative to the specified image orientation; and provide instructions for rotation in real-time of the image capturing device, to compensate for the shift; and a rotation mechanism configured to rotate the image capturing device based on the instructions.

According to some embodiments of the present invention, the specified image orientation is selected so as to reduce capturing of regions of the area indicated as non-relevant regions. In some embodiments, the specified image orientation may be changed dynamically over time.

FIG. 7D is a diagram of a ship illustrating an aspect in accordance with some embodiments of the present invention. The ship captures via an image capturing device mounted on it, a specified region of interest 780 while it moves along routes 772 and 774 from locations 770A, to 770B, and 770C wherein the orientation of the capturing device changes as the ship moves due to waves and other sea conditions. In accordance with embodiments of the present invention, the capturing device is rotated in real time to compensate for the monitored area 780 cropping due to shift in orientation caused by the waves and movement from one location to another while covering one or more region of interest 780. The same principles may apply also to an aerostat.

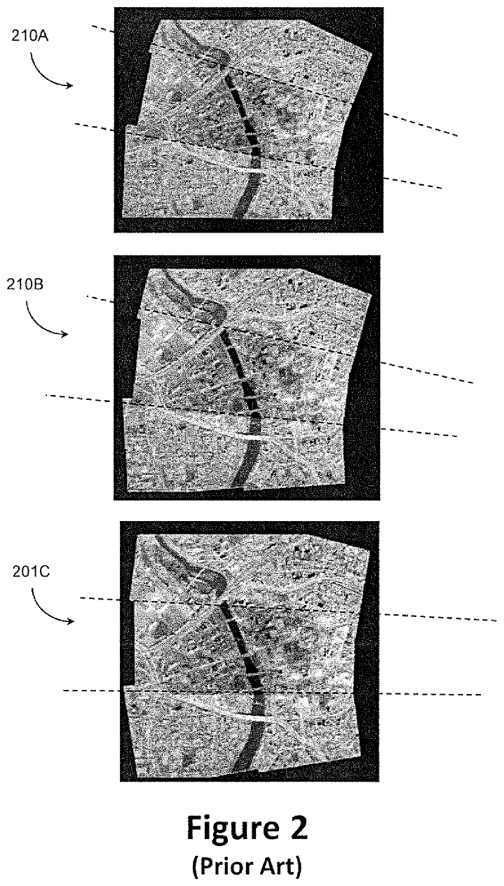

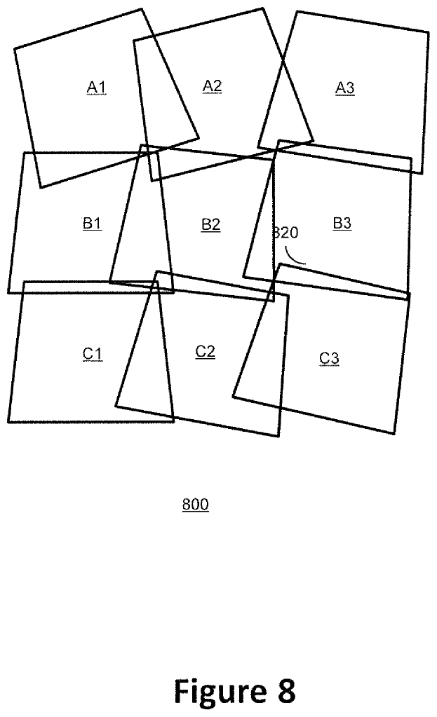

FIG. 8 is a diagram illustrating 3×3 array of tile images captured by an image capturing device According to some embodiments of the present invention, the capturing device is configured to capture a set on partially overlapping NxM tile images, wherein the selective rotation of orientation is applied to each of the NxM tile images so as to compensate a respective shift for each of the NxM tile images separately. The NXM tiles may be achieved by the use of internal scanning mechanisms, the use of multiple cameras/arrays or any combination of the above. coverage area 800 includes areas A1, A2, A3, B1, B2, B3, C1, C2, and C3 being the tile images set to desired orientation in real-time so at to compensate for the respective shift in orientation due to change in position of orientation of the aerial vehicle capturing them. It is evident that the coverage of the area in terms of the A1, A2, A3, B1, B2, B3, C1, C2, and C3 is much better than the coverage achieved by image processing as discussed above and illustrated in FIG. 2 in accordance with post capturing compensation achieved by software based image rotation in accordance with the prior art.

According to some embodiments of the present invention, the capturing device may be configured to capture a set of partially overlapping N×M tile images constituting one large image, wherein each of the N×M tile images is associated with a respective specified image orientation and wherein the computer processor and the rotation mechanism are further configured to operate for each of the N×M tile images separately, based on the respective specified image orientations. Which

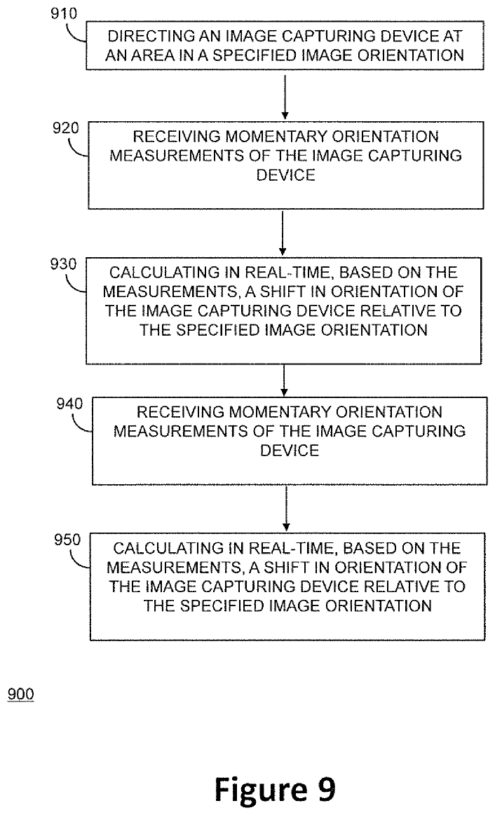

FIG. 9 is a high level flowchart illustrating a method 900 of increasing an area continuously captured by an image capturing device directed at the area. Method 900 may include the following steps: directing the image capturing device at the area in a specified image orientation 910; receiving momentary orientation measurements of the image capturing device 920; calculating in real-time, based on the measurements, a shift in orientation of the image capturing device relative to the specified image orientation 930; providing instructions for rotation in real-time of the image capturing device, to compensate for the shift 940; and rotating, using a rotation mechanism, the image capturing device based on the instructions 950.

As will be appreciated by one skilled in the art, aspects of the present invention may be embodied as a system, method or an apparatus. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The aforementioned flowchart and block diagrams illustrate the architecture, functionality, and operation of possible implementations of systems and methods according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention.

1. A system for increasing an area continuously captured by an image capturing device directed at said area, the system comprising:
an image capturing device directed at said area in a specified image orientation;
a rotation mechanism configured to rotate said image capturing device; and
a computer processor configured to:
receive momentary orientation measurements of said image capturing device;
calculate in real-time, based on said measurements, a shift in orientation of said image capturing device relative to said specified image orientation;
provide instructions to said rotation mechanism for rotation in real-time of said image capturing device, to compensate for said shift,
wherein said image capturing device is mounted on a non-stationary platform moving in a periodic pattern.

2. The system according to claim 1, wherein the platform is an aerial platform and wherein the periodic pattern is a flight route.

3. The system according to claim 2, wherein said flight route is circular.

4. The system according to claim 1, wherein the platform is one of: a naval vessel, a ground vehicle, an aerostat, and a semi-stationary platform.

5. The system according to claim 1, wherein the specified image orientation is selected so as to reduce capturing of regions of said area indicated as non-relevant regions.

6. The system according to claim 1, wherein the specified image orientation is determined by one of: an automatic decision module, a human operator.

7. The system according to claim 1, wherein said capturing device is configured to capture a set of partially overlapping N×M tile images constituting one large image, wherein each of said N×M tile images are associated with a respective specified image orientation and wherein the computer processor and the rotation mechanism are further configured to operate for each of said N×M tile images separately, based on the respective specified image orientations.

8. The system according to claim 1, wherein said image capturing device has an aspect ratio of over 1:R, where R>2, wherein the rotation yields an increase in the captured area by a sequence of captured images, of at least R times, compared to a similar area without said rotation.

9. The system according to claim 1, wherein the rotation mechanism comprises at least one gimbal.

10. The system according to claim 1, wherein the rotation mechanism comprises a Schmidt-Pechan prism having two parallel surfaces.

11. The system according to claim 10, wherein the width of the beam of the image at the beam input side of Schmidt-Pechan prism and the width of the beam at beam output side of Schmidt-Pechan prism are similar in size.

12. The system according to claim 1, wherein said image capturing device is configured to capture at least two non-overlapping images each associated with a respective specified image orientation and wherein the computer processor and the rotation mechanism are further configured to operate for each of the non-overlapping images separately, based on the respective specified image orientations.

13. A system for preserving a specified image orientation of images captured by an image capturing device, the system comprising:
an image capturing device directed to scan an area in a specified image orientation;
a rotation mechanism configured to rotate said image capturing device; and
a computer processor configured to:
receive momentary orientation measurements of said image capturing device;
calculate in real-time, based on said measurements, a shift in orientation of said image capturing device relative to said specified image orientation;
provide instructions to said rotation mechanism for rotation in real-time of said image capturing device, to compensate for said shift; and
a rotation mechanism configured to rotate said image capturing device based on said instructions,
wherein said image capturing device is mounted on a non-stationary platform moving in a periodic pattern.

14. The system according to claim 13, wherein the specified image orientation is determined by one of: an automatic decision module, a human operator.

15. The system according to claim 13, wherein the specified image orientation is selected so as to reduce capturing of regions of said area indicated as non-relevant regions.

16. The system according to claim 15, wherein the specified image orientation is changed dynamically over time.

17. A method of increasing an area continuously captured by an image capturing device directed at said area, the method comprising:
directing said image capturing device at said area in a specified image orientation;
receiving momentary orientation measurements of said image capturing device;
calculating in real-time, based on said measurements, a shift in orientation of said image capturing device relative to said specified image orientation;
providing instructions for rotation in real-time of said image capturing device, to compensate for said shift;
rotating, using a rotation mechanism, said image capturing device based on said instructions,
wherein said image capturing device is mounted on a non-stationary platform moving in a periodic pattern.

18. The method according to claim 17, wherein the platform is an aerial platform and wherein the periodic pattern is a flight route.

19. The method according to claim 18, wherein said flight route is circular.

20. The method according to claim 17, wherein the platform is one of: a naval vessel, a ground vehicle, an aerostat, and a semi-stationary platform.

21-32. (canceled)
